(19) United States
(12) Patent Application Publication
(10) Pub. No.: US 2014/0144319 A1
(43) Pub. Date: May 29, 2014

(54) ORBIT FILTER MAGNETS FOR CYCLONIC CLEANERS

(71) Applicants: JOHN J. PAOLUCCIO, Modesto, CA (US); John A. Paoluccio, Modesto, CA (US)

(72) Inventors: JOHN J. PAOLUCCIO, Modesto, CA (US); John A. Paoluccio, Modesto, CA (US)

(21) Appl. No.: 13/686,816

(22) Filed: Nov. 27, 2012

(51) Int. Cl. B01D 45/16

(52) U.S. Cl. CPC B01D 45/16
USPC 95/78; 95/271

(57) ABSTRACT

A method for agglomerating dust particles in a cyclone dust apparatus which includes providing a cyclone dust removal apparatus that includes a housing; depositing a plurality of objects having affinity for particulate matter within said housing; directing a fluid stream having particulate matter disposed therein into the cyclone dust removal apparatus; and operating the cyclone dust removal apparatus whereby agglomeration of ambient particulate matter on respective objects occurs.

### RELATED APPLICATIONS

This application is a continuation of U.S. provisional patent application 61/565,097 filed on Nov. 30, 2011 which application is incorporated by reference herein in its entirety.

### FIELD OF THE INVENTION

The invention has particular application to methods and apparatus for cleaning/filtering gases including ambient air in cyclone bagless vacuum cleaners as well as other filtration applications such as air conditioning filters that filter air and room air cleaning apparatus. In addition the invention has application to industrial cyclone dust collection apparatus such as that disclosed in U.S. Pat. No. 2,583,696 issued to Hans Held which is incorporated by reference herein. While the invention will be described in terms of cyclone vacuum cleaners, those skilled in the art will recognize the applicability to cyclone dust collection apparatus that are used to collect sawdust as well as other industrial process byproducts. Such dust collection apparatus is used in industrial processes including but not limited to abrasive blasting and shot blast; cement and minerals; chemicals and plastics; food processing; foundries; glass; grain, agriculture and feed; mining and mineral products; pharmaceutical; thermal spray; welding fumes; wet machining (Mist Collection); and woodworking. As used herein the term “dust” is used to refer to as a generic term that includes both dust as well as other such byproducts and other particulate matter.

Furthermore, the present invention has application to a wide variety of apparatus and methods utilizing cyclonic separation. Cyclonic separation is a method of removing particulates from an air, gas or liquid stream without the use of filters through vortex separation. Rotational effects in gravity are used to separate mixtures of solids and fluids. The method can also be used to separate fine droplets of liquid from a gaseous stream.

In a typical cyclonic separation apparatus a generally cylindrical housing is provided having a tangentially disposed air inlet near the uppermost extremity of a cylindrical housing. Fixed to the cylindrical housing at the lower extremity thereof is a truncated conical member of having a smaller axial extremity at the lowest elevation. Air moves in a generally helical pattern within the cylindrical housing toward the lowest extremity of the conical member. Relatively heavily heavy and dense particles exit from the housing at the relatively small opening of the conical member. The remaining lighter and cleaner fluid rises axially within the cylinder cohousing to an outlet at the top of the cylindrical housing.

Large-scale cyclones are used in sawmills to remove sawdust from extracted air. Cyclones are also used in oil refineries to separate oils and gases, and in this ministry as components of kiln pre-heaters. Such apparatus are used not only in portable vacuum cleaners in addition to central vacuum cleaner systems. Cyclones are also used in industrial and professional kitchen ventilation systems for separating grease from the exhaust air. Smaller cyclones are used to separate airborne particles for analysis. Some are small enough to be worn clipped to clothing, and are used to separate respirable particles for later analysis. Analogous devices for separating particles or solids from liquids are called hydrocyclones or hydroclones. Applications for such apparatus include separation of solid waste from water and wastewater and sewage treatment applications.

### BACKGROUND OF THE INVENTION

The prior art includes early vacuums that mainly used a filter bag to filter out the collected dust. The dust bags were either replaced when full or cleaned. This type vacuum simply filtered out the dust. With bagged vacuum cleaners it is difficult to determine when dust bag replacement is necessary.

Cyclone type bagless vacuum cleaners have become very popular because the user can see the dust collected making is easy to tell when it is time to empty the collected dust in the dust cup. These units utilize a clear plastic housing that is part of the cyclone dust separation system that includes a clear dirt cup at the bottom of the housing to hold collected dust. A flip open hinged bottom allows for ease of dumping with a quick release latch.

The collected household dust may include dust, human hair, pet hair, lint, dirt, minerals, chemicals, pollen, and dust mites, insects both live and dead. The term “dust” includes all the above contaminants collected and more.

State of the art vacuum cleaners use cyclone technology to accomplish bag free filtration. The vacuumed dirty air enters the cyclone portion at high air velocity. As the dust swirls' around the cyclone portion of the housing, the heavier particles settles out and descends to the bottom of the cyclone into the dirt cup. The upper portion of the cyclone generally has the highest air velocity and the velocity progressively decreases at the lower portion at the dust cup area. The cleaner air that contains more of the light finer dust exits the vortex tube and is routed through dust filters that may include a HEPA filter.

Prior art bagless vacuum cleaners include the filtered cyclonic separation structure that utilize high velocity centrifugal airflow action to separate the dust, dirt and debris from the vacuumed air before the treated air is further filtered and released back into the room. The housing is usually clear plastic and includes a dirt cup at the lower portion to hold the collected dust. Many variations exist in cyclone type bagless vacuums, however, even the best do not remove all of the fine dust in the cyclone portion of the apparatus.

These units may also have dust filters and or HEPA filters. One can easily see the dust swirling within the clear housing above the dirt cup. The dirt cup has a quick release lever to remove it from the vacuum. A releasable door on the bottom of the dust cup is “opened” to dump the collected dust.

Other prior art vacuum cleaner filtration methods include bag type vacuum cleaners: The primary method of air filtration is the use of a filter bag where dust laden air flows into the filter bag. The dust particles are captured by the filter bag as the dirty air passes through the filter bag and treated air exits the filter bag and reenters the room. The more dust it collects, the dirtier it becomes and the air resistance increases and the air flow decreases.

Known industrial bag house dust collection filters utilize filters comprising dust bags that become dirty with collected dust. Surprisingly such structures are actually more effective in capturing more of the fine dust. However, the flow rate decreases as the dust builds up air resistance. In fact the collected fine dust builds up as a mat on the surface of the filter fabric or media and filters out more of the fine particles. Some industrial bag house filters take advantage of this and periodically pulse or shake the dust bag filter to drop out the collected dust that is on the surface of the filter media. Some fine dust remains on the dust bag filter media surface and continues to work for long periods of time at high efficiency with frequent pulses to help clean off surface dust. In essence, the filter media may be even considered as a strainer that holds onto a mat of collected dust and the dust acts as a filter. Some commercial size vacuum cleaners use a filter bag and dirt cup similar to the above without the cyclone portion. Fine dust buildup increases the pressure drop across all panel, pleated, bag and even HEPA filters and reduces flow rate. The dirty filters need to be cleaned or replaced to maintain a desired flow rate.

Dust laden air enters the upper portion of a cyclone separator at high velocity at a tangent point. The cyclone uses the centrifugal force from air circulating around and around a vertically elongated cylinder. The larger, heavier and denser dust particles reach the greatest orbit position and descend to the bottom of the cyclone cylinder shaped housing. The treated air, with the fine dust particles, exits the vortex tube in the center of the cyclone. When the cyclone separation treatment method is used on bagless vacuum cleaners the exhaust air from the cyclone portion requires further dust removal by additional filters and may include a final HEPA filter.

The problems with prior art cyclone bagless vacuums include the dispersal of dust that occurs when the dust cup is removed and the collected dust emptied. When the cup is removed and emptied a plume of fine dust immediately is released into the air. This is hereinafter referred to as fugitive dust. This fugitive dust when released back in the room air causes health, sanitation and nuisance problems. The household dust collected from a vacuum cleaner may contain fine dust, sand, grit and other soil particles, synthetic and woolen fibers, pet fur, skin scales, flea droppings, flea eggs, dust mites, pollen and many other chemical and mineral contaminates. A large portion of the fine dust is in the PM 2.5 range and sub-micron range where it is a health hazard to anyone breathing this fine dust.

When emptying the dust cup of cyclone bagless vacuums, nuisance and harmful duct particles can expose the user and aggravate allergies, asthma and other respiratory diseases. The dust may also contaminate eyes, hair, clothing and escape back into the home. The interior of the clear housing dirt cup becomes coated with dust that obscures the clarity of the clear housing. This requires washing and cleaning to restore visibility.

The bagless vacuums use cyclone technology to separate the heavier denser particles from the fine lighter dust. The fine dust not removed by the cyclone action is routed through dust filters that may include a HEPA filter before the filtered air exits the vacuum and enters the room. These dust filters and HEPA filters quickly becomes plugged with fine dust particles resulting in restriction of exhaust air flow. This in turn reduces the vacuum air flow and suction. With less air flow, less dust is removed from the floor surface and the cyclone dust separation performance is decreased and this adversely affects the overall performance of the vacuum unit. It is a common problem for the user to not inspect the dust filters because they still can see the dust and debris spinning around in the clear cyclone housing. These filters need to be cleaned or replaced as recommended by the manufacturer in order to maintain proper performance.

Large dust particles are not normally considered as serious a health problem as they settle out of room air fairly quickly. It is the fine particles that tend to remain suspended for long periods of time in the room air. They can be inhaled deeply into the lungs and become lodged in delicate tissue causing a number of health and respiratory problems.

The term PM₁₀ refers to dust particles larger than 10 microns. The term PM_{2.5} refer to dust particles smaller than 2.5 microns. The fine fugitive dust emitted from the emptied dirt cup is mainly in the PM_{2.5} ranges. Large dust particles above 10 micron size tend to settle out faster while the finer 2.5 micron size and smaller can stay afloat for hours in the room.

The health effects of PM₁₀, PM_{2.5} and smaller particles can be found in: Wikipedia, the free encyclopedia describes in detail dust particles: http://en.wikipedia.org/wiki/Particulates

### SUMMARY OF THE INVENTION

It has now been determined that these and other objects of the present invention may be achieved in a method for agglomerating dust particles which includes providing a plurality of objects having affinity for particulate matter within said housing and causing fluid flow to agitate the objects whereby agglomeration of ambient particulate matter on respective objects occurs.

Other embodiments of the present invention include the method for agglomerating dust particles in a cyclone dust apparatus which includes providing a cyclone dust removal apparatus that includes a housing; depositing a plurality of objects having affinity for particulate matter within the housing; directing a fluid stream having particulate matter disposed therein into the cyclone dust removal apparatus; and operating the cyclone dust removal apparatus whereby the objects within the housing accumulate particulate matter thereon.

In some embodiments of the method each of the plurality of objects is dimensioned and configured to circulate within the housing of the cyclone dust removal apparatus responsive to fluid flow normally occurring therein. The method may include the step of providing a plurality of objects includes providing objects that preferably have large extended surface areas. In various forms of the invention the objects provided may be fabricated from a filter media; fabricated from a polypropylene filter material; fabricated from a material having an intermolecular attraction to particular matter in the housing; utilize objects having electrostatic attraction to particulate matter in the housing; or utilize objects that have physical characteristics wherein passage of the object along the interior of the housing creates an electrostatic charge on the respective objects.

In other embodiments of the method the objects are attracted to particulate matter by eddy diffusion. Brownian motion are fabricated from a microfiber and/or dimensioned and configured to be light in weight, have low density, have a large surface area, and sufficiently small in size to permit circumvent the interior of a housing. Some embodiments include a plurality of objects that include respective objects that vary with respect to shape, size, density, and/or surface area. In some embodiments the cyclone apparatus is a vacuum cleaner.

The invention also includes a method for agglomerating dust particles in a housing which includes providing a housing having upstanding sides, an inlet an outlet; depositing a plurality of objects having affinity for particulate matter within the housing; and directing a fluid stream into the housing having particulate matter disposed therein into the housing; whereby the objects are displaced continuously to accumulate particulate matter thereon from the interior of the housing.

The method may further including the step of providing a fan for causing fluid flow in the housing thereby increasing the movement of the plurality of objects and thereby causing additional agglomeration of particulate matter.

The method may include the utilization of e plurality of objects that are fibrous and porous and/or fabricated from a filter media, fabricated from a polypropylene filter material.

### BRIEF DESCRIPTION OF THE DRAWING

The foregoing and other objects, features and advantages of the invention will be apparent from the following more particular description of illustrative embodiments of the invention, as illustrated in the accompanying drawings in which like reference characters refer to the same parts throughout the different views. The drawings are not necessarily to scale, emphasis instead being placed upon illustrating the principles of the invention. Those skilled in the art will understand that the devices and methods specifically described herein and illustrated in the accompanying drawings are non-limiting exemplary embodiments. The features illustrated or described in connection with one exemplary embodiment can be combined with the features of other embodiments. Such modifications and variations are intended to be included within the scope of the present invention.

FIG. 1 is a schematic diagram of the Orbit Filter Magnet (OFM) in a dirty air stream showing fine and large dust particles near and on the OFM. It also shows a larger clump of dust particles that have broken away from the OFM that now acts like a fibrous filter particle that captures more dust particles.

FIG. 2 is a partial schematic diagram view of a cyclone bagless vacuum that illustrates the air path, dust and OFM's when a cyclone vacuum is in operation.

FIG. 3 is a schematic horizontal cross section of the cyclone portion of the vacuum housing that shows the circular air path with dust and OFM's.

FIG. 4 is a schematic view of a room air cleaner that uses OFM's that recirculate in the airstream within the fan and airflow assembly in a turbulent path that helps remove dust particles from the room air. Similar air cleaning apparatus may clean air passing into or out of an air conditioning housing.

### DESCRIPTION OF THE PREFERRED EMBODIMENTS

It is noted that the terms “first,” “second,” and the like, as well as “primary,” “secondary,” and the like, herein do not denote any amount, order, or importance, but rather are used to distinguish one element from another, and the terms “a” and “an” herein do not denote a limitation of quantity, but rather denote the presence of at least one of the referenced item. The suffix “(s)” as used herein is intended to include both the singular and the plural of the term that it modifies, thereby including one or more of that term (e.g., the bearings(s) includes one or more bearings). The endpoints of all ranges directed to the same component or property are inclusive and independently combinable (e.g., ranges of “up to about 5°, or, more specifically, about 0.5° to about 3° ” is inclusive of the endpoints and all intermediate values of the ranges of “about 0.5° to about 5°,” etc.).

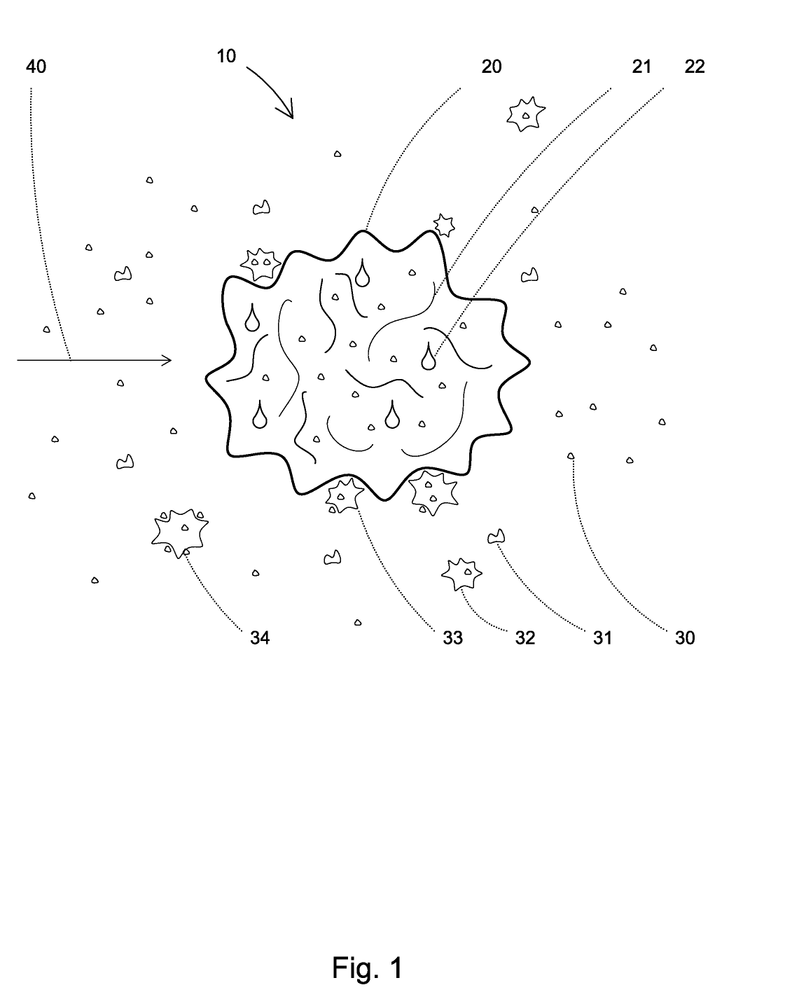

FIG. 1 is a schematic view within a cyclone dust removal apparatus 10 illustrating a part of the orbital paths of an OFM 20 showing its fibrous 21 structure and on which is disposed a viscous impingement oil 22. Fine dust particles 30 as well as larger particles 31 collect on the surface of the OFM 20. Dust particles 31 may have a larger or “smaller diameter orbital path. Clumped dust particles 33 accumulate on the surface of the OFM 20 resulting in still more accumulation of clumped 33 dust particles that may break away and form large clumped dust particles 34.

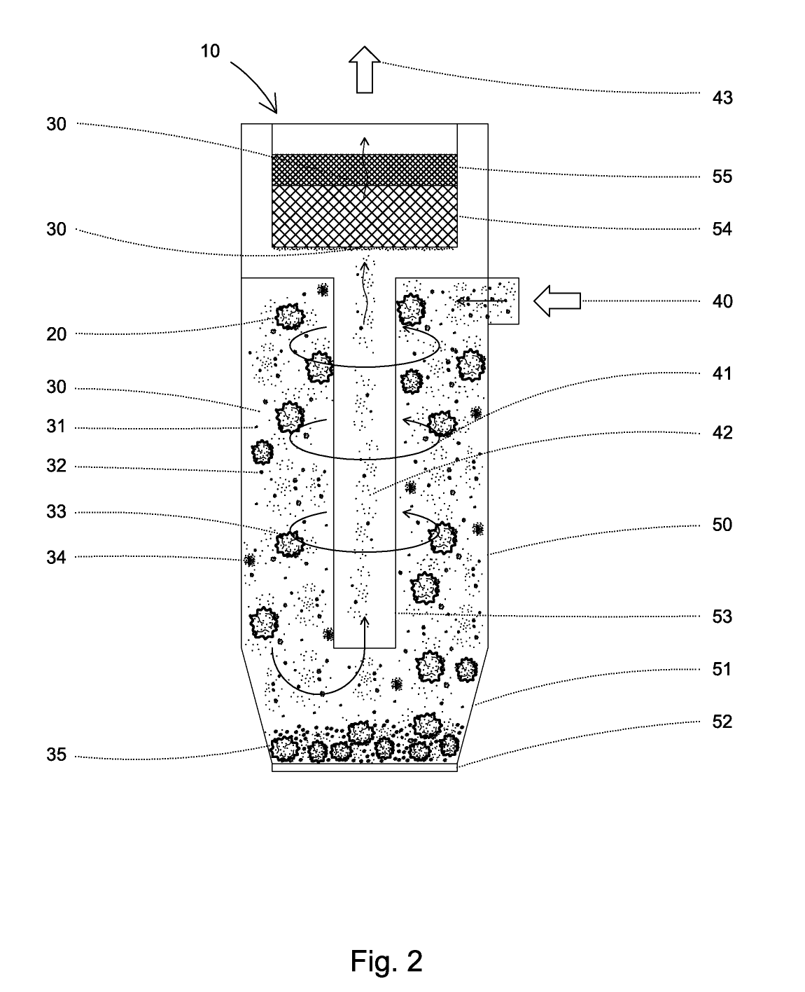

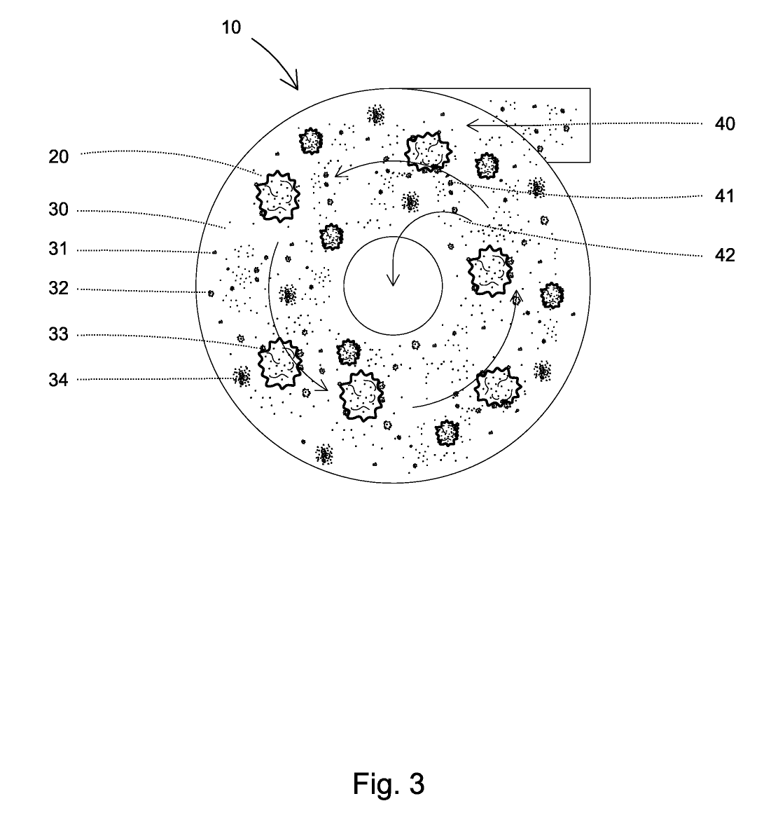

FIG. 2 is a schematic view of the cyclone portion 50 and dust cup 51 of a bagless vacuum cleaner. A plurality of OFMs 20 orbit around a vortex or vortex tube 53 as well as large dust particles 31, clumped dust particles 33, clumped dust particles 34 that have captured large dust 31 and fine dust 30. Collected dust 35 is shown at the bottom of the housing. Dirty air 40 enters an inlet port on the right hand side of the housing and passes around the vortex 53. Thereafter, the air 42 after extraction of most fine dust 30 passes up through the vortex 53 and reaches a HEPA filter 55 as well as another filter 54. A dust cap 52 is hinge mounted to the cyclone housing 50. FIG. 3 is a cross-sectional view of the apparatus shown in FIG. 2.

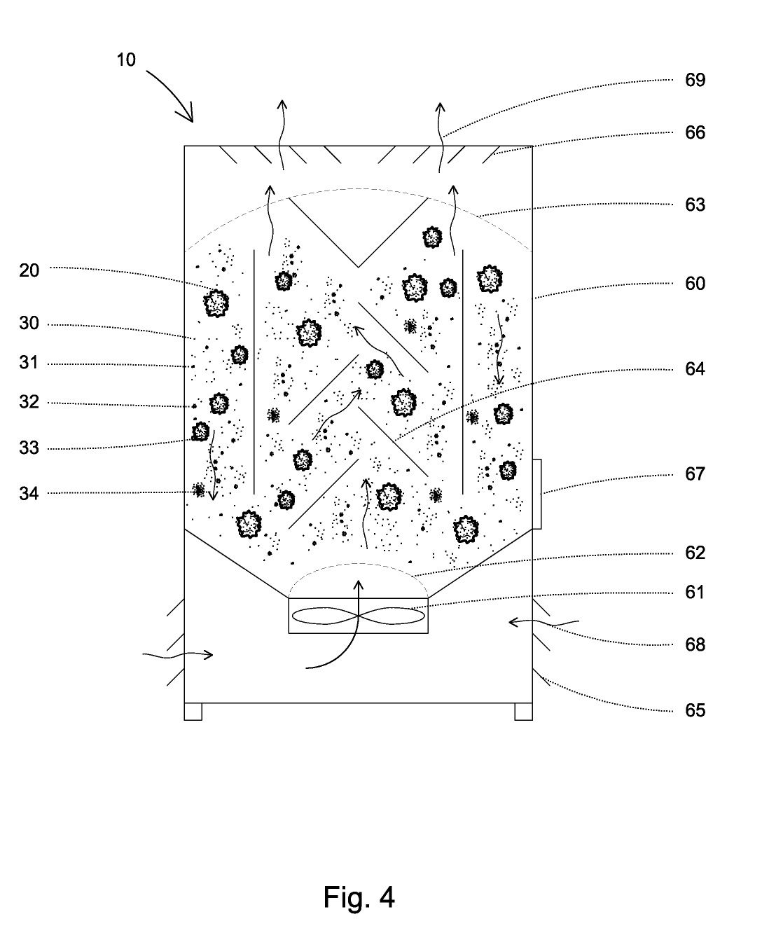

FIG. 4 is a schematic/diagrammatic view of a room air cleaner 68 that also uses the OFM particles 20. Room air 68 enters the apparatus near the lower side faces and is forced upward by a fan into a central chamber. A screen 63 prevents the escape of the OFM objects. The fan causes the OFM 20 objects as well as the dust 30, 31, and clumped dust particles 32 on an OFM 20 in addition to clumped dust particles 34 that have captured fine dust 30 are circulated by the fan. Accordingly the fine dust particles are collected in the same manner that occurs in all embodiments of the present invention.

The object of this invention is to utilize the high velocity circulating action in the cyclone housing of the bagless vacuum to utilize a new filtration technology called Orbit Filter Magnets (OFM's) to help capture the spinning fine dust particles within the dirt cup. The term “magnets” as well as the term “magnet” refers to a property of such objects that has an affinity for dust in the case of a vacuum cleaner or other particulate matter in various industrial processes. In a cyclone vacuum cleaner the OFM's capture or conglomerate the fine dust particles in the dirt cup of such bagless vacuum cleaners, into larger masses on and within the OFM's that prevent their release as fugitive dust when the dirt cup is removed and emptied. The name of this technology is based on the Orbit like circular motion of the objects. In some embodiments of the present invention the objects are manufactured from filter material. Such a material is of course fibrous and or porous and that is a desirable characteristic for such objects. The fibrous structure or porosity allows air or other gases materials to pass deep into or through the objects and thereby collect fine dust on the inner and outer surface of the objects. In normal operation the OFM objects spinning around and around within the cyclone housing while capturing more and more of the fine dust particles like a magnet.

Not only do the respective OMF's collect the fine particles, they also attract additional fine particles including substantially all the other dust particles within the dirt cup. These fine particles in turn either adhere to the OMF or break away into clumps that help collect additional fine dust particles. The result is virtually all the fine dust is on or within the OMF's or the activated clumps that may break off from such OFMs.

When emptying the dirt cup of present cyclone vacuum cleaner units, nuisance and harmful fugitive dust particles can expose the user and aggravate allergies, asthma and other respiratory diseases. The dust may also contaminate eyes, hair, clothing and escape back into the home. With the use of this OFM invention virtually no fugitive dust occurs when emptying the dirt cup. Other objects of the invention include reducing dust related problems, static electricity, and dust explosions particularly in industrial applications as well as contamination control, reclaiming fines, powders and material from other applications wherever dust is generated. This includes homes, factories, processes, medical, food processing and others.

The method in accordance with one form of the present invention includes providing a cyclone apparatus for separation of particulate matter by providing a plurality of discrete objects that are dimensioned and configured to circulate within the cyclone section of the apparatus. Thus, the plurality of discrete objects will be caught up in the fluid flow within the cyclone apparatus where they will follow a path that may approach a helical path. As more particles become conglomerated with such objects the weight of the individual particle increases and thus the object with the increased mass will inherently move closer to the lower extremity. Disposed within the air stream within the cyclone apparatus in a typical embodiment are OFM's that may be small fibrous or porous pellets within the dust laden moving air stream in the cyclone section of the dust cup. Dust particles are captured by the OFM's or fibrous pellets by impingement, diffusion, and/or electrostatic charge attraction in a cyclone bagless filter. The filter technology in accordance with the present invention greatly increases the capture, removal and conglomeration of the finer dust particles into larger dust particles. The term conglomeration herein is used to refer to a cohering mass or cluster that includes many dust particles.

Normally the vacuumed dust enters the clear housing above the dirt cup at high air velocity and dust separation occurs through the cyclone action or centrifugal force as the heavier dust settles to the bottom of the dirt cup. The finer and lighter dust tends to stay in suspension longer and the fine dust that is not captured exits the inner vortex tube within the center of the cyclone dust cup leading to dust filters and the HEPA filter and then exit back into the room.

This OFM apparatus and method in accordance with one form of the present invention uses a number of small lightweight fibrous or porous filter pieces or modules that are each shaped as pellets, balls, pads or cubes with extended surface areas that are introduced into the cyclone housing dirt cup of a cyclone bagless vacuum cleaner after each dumping of the dust cup. The OFM's may be made of microfiber pieces, reticulated foam that is porous with an open cell structure and or made of fine fiber polypropylene filter material and other materials for weight, shaping and other properties.

In one preferred form of the invention a packet of up to 80 small OMF's would occupy a volume of several cubic inches with a combined weight that in one embodiment weighs 0.2 ounces. The respective OMF's in some embodiments may have as many as 5 different size, shapes and densities of predominately microfiber filter pods with extensive surface areas. A small amount of viscous impingement oil or mineral oil may be impregnated in the microfiber filter pods for aiding in the capture and holding onto of fine dust as it builds up on the OFM. These features help accomplish a broader range of orbit circulating positions within the cyclone chamber for maximum fine dust particle capture.

The heavier and denser OMF's may have the largest orbit radius and orbit the space where the larger heavy dust particles would be within the cyclone chamber. These OMF's would also help clean the clear housing. As they capture dust particles the shape and density and orbit position changes and that is desirable.

The medium density OMF's may mainly orbit the middle and inner space of the cyclone chamber but these will also change orbit positions as they capture dust particles. The lighter density OMF's may mainly orbit the space where the lightest and finest dust particles are that are close to the vortex tube. These will also change orbits as dust is collected.

All the above OFM's will collect dust and some will become heavy and descend to the bottom of the cyclone portion and drop into the dirt cup where it may swirl around and helping conglomerate the already dropped out dust in the dirt cup. This continuous contact with all the dust helps keep all the dust collected in larger dust free clumps. When the vacuum stops, all the spinning OFM's stop spinning and drop into the dust cup until it is emptied.

During operation when the vacuum is on, some of the lightest OFM's may be drawn into the vortex where they may help coat the pre-filter. These OFM's then act as a deep bed loading filter further collecting fine dust while helping keep the pre-filter cleaner and extending the downstream HEPA filter life. When the vacuum is turned off some of these OFM's and the collected dust may also drop through the vortex tube and into the dirt cup.

Providing OMF's with different shapes and different densities insure more contact with the broad range of dust particles spinning around the cyclone before the fine particles reach the vortex. However, even if one size, shape and density OFM is used a fairly high degree of dust capture is accomplished. Using a uniform size has certain manufacturing advantages.

Test experience has demonstrated that a variety of shapes and sizes of OMF's that include from ¼″ cubic inches, approximately ⅜″ cubes and up to ½″ cubes all with extended surface area, remained in a broad range of orbits and captured more fine dust than using a single size and shape OMF. Odd dimensions such as ⅜″ by ½″ by ⅛″ may also be used. The shape may be square, round, rectangular or a triangle. All sizes work best with an extended surface area. These may also range in specific density for best performance.

The OFM's circulates within the dirt cup at a very high rate of speed, circulating around and around the interior of the dirt cup along with the fine dust, dirt and debris. The heavier dirt particles settle to the bottom of the dirt cup. The lighter finer dust particles and the OFM's circulate within the dirt cup nearer the vortex. The circulating fine dust particles come in contact with the OFM's again and again at the high speed centrifugal action of the cyclone until the dust particle is captured or until it exits the vortex. The OFM's circulate around and around as long as the vacuum in “On”. The OFM's quickly become dirty and covered with fine dust. Some of the captured dust builds up in size by interlocking small fine particles with different shapes that tend to coagulate into a larger heavier mass that breaks away from the OMF and acts as a larger heavier and denser particle and descends to the bottom of the dirt cup.

Therefore, the OFM's not only capture the fine dust but it also densified the other dust particles by combining them. This minimizes any fugitive fine dust remaining in the dirt cup when the vacuum turns “Off”. The OFM's are simple discarded with the dirt, dust and debris in the dirt cup when emptied. Virtually no fugitive dust exits the OFM treated dirt cup.

The material of the OFM's may become electrostatically charged from the friction of the high speed moving air in contact with the surface material of the OFM's and with the clear plastic cyclone portion of the housing dirt cup. The orbiting electrostatic charged OFM's attracts the fine dust particles to the extended and porous surfaces of the OFM's like a magnet. Fine dust is also captured on and within the OFM's by impingement and diffusion. Microfiber material is ideal as a electrostatic material for attracting dust. Microfiber dusters and cleaning cloths come in a variety of shapes and sizes. Some microfiber dusters have a large number of noodle like microfiber strands that provide a extensive surface area. Each strand is composed of thousands of extremely small microfibers that attract and hold onto the dust.

Cyclone type bagless vacuums with circulating OFM's rely on one or more of four basic principles of dust capture operations which apply to the cyclone centrifugal air flow and circulating OFM's system. These include Inertial Separation, Impingement, diffusion and electrostatic capture.

Inertial Separation: Particles are separated from air stream by centrifugal force.

Impingement: The force that holds a particle to a surface by Van Der Force (Intermolecular attraction). A bonding media may be added to the OFM's material for viscous impingement feature.

Diffusion: Brownian motion and eddy diffusion help put very fine particles in contact with the OFM's surfaces.

Electrostatic: High velocity air passes over the OFM's plus contact with the plastic housing produces friction that creates a natural electrostatic charge on the surface of the OFM's. The electrostatic charge attracts minute dust particles like a magnet.

The OFM's inside the cyclone portion of the dirt cup travel at a high rate of speed, in a circular motion, many times a minute. The vacuumed air carrying dirty air at a broad range of particle sizes also flows in the circular motion within the cyclone portion of the dirt cup. This operation keeps the OFM's pellets in close contact with the dirt particles hundreds or thousands of times more than conventional one pass filters.

The heavier and denser particles tend to flow at the outer portion of the circular path and they continually descend to the bottom of the dirt cup. The lighter and finer particles tend to remain suspended in a circular orbit or path that is spaced away from the outer wall that is typically cylindrical. The very fine small light particles tend to not descend to the bottom of the dirt cup until the vacuum is turned “off”.

The suspended OFM's tend to move in a more irregular circular path and the chance of contact with dirt particles increase with every pass. When contact occurs the dust particle may enter and make surface contact to a portion of the OFM and be captured by impingement or attraction by electrostatic charge.

Other dust particles come in contact with the already captured dust particles and once in contact, tend to bond together in a conglomerated mass. The physical shapes of the fine dust particles are irregular and they tend to stick together and build up in size as more and more dust particles come together. As the conglomerated mass increases and becomes denser it tends to descend to the bottom of the dirt cup.

The OFM's become coated on all its irregular surfaces with dust particles and fine dust particles continues to be captured until virtually no free fine dust particles exist. The fine dust particles are either captured in the OFM's or conglomerated in a heavier mass at the bottom of the dirt cup. What is not captured is passed through the exhaust filters.

In one variation of the OFM's, some of them may be much lighter than the others and these may travel more quickly with the fine dust that is not captured in the cyclone portion. Theses lightweight OFM,s and fine dust travel up the vortex 53 where they tend to cover the exposed filter surface. These OFM,s then act as a deep bed loading pre-filter and when the vacuum is stopped they tend to drop back through the vortex tube into the dust cup with the other OFM's.

During the vacuuming the OFM's bounce around in a circular pattern and occasional may come in contact with the interior clear surfaces of the dirt cup. This tends to wipe the interior clear housing surfaces clean of dust for better viewing.

Any slight irregular surface on the interior of the dirt cup causes non-uniform circular air flow and that increases turbulence and increases the change of fine particle contact with the OFM's. As the OFM's capture dust particles the shape and uniformity changes and this also causes non-uniform circular air flow and that increases turbulence and increases the change of fine particle contact with the OFM's.

When the vacuum is turned “off” the collected dust and OFM's drop to the bottom on the dirt cup. When the dirt cup, including the cyclone housing, is removed from the vacuum and the bottom door “opened” to dump the collected dust, virtually no fugitive dust escapes from the dirt cup and dumped dust as it is emptied. The dumped dust tends to hold onto all the fine dust with no visible fugitive dust escaping and entering the surrounding area. The dust cup may be 6 to 12″ above the trash container when dumping the dust. Without OFM's the descending fine dust would be carried away by the normally moving room air and spread and mix within the room as fugitive dust.

The bagless vacuum with OFM's in the dirt cup will solidify, capture, and or make dust free disposal of collected household dust, dirt and debris in the dust cup that will prevent re-entry of fine dust back into the air during disposal.

Advantages of this invention: The advantages of this invention include the following:
Most of the fine dust is captured, coagulated and solidified or on and within the fibrous OFM's.
Virtually all fine dust within the cyclone is captured into larger heavier particles that settle out and enter the bottom portion of the dirt cup.
Accumulated fine dust particles build up and clump together on the fibrous OFM's pellets and the parts of the clumps break away and become fibrous filter pellets that remove more fine dust particles.
When emptying the dirt cup the solidified fine dust particles, on and within the fibrous OFM's, no longer pose a nuisance.
The user is no longer exposed to the harmful duct particles that can aggravate allergies, asthma and other respiratory diseases.
The users eyes and clothing no longer are contaminated with fugitive dust when emptying the dirt cup.
Fugitive dust no longer re-enters the room.

The fibrous OFM's pellets help clean the interior surface of the clear plastic housing dirt cup thereby reducing the need to wash it. In addition, the simplicity of use encourages users to utilize the OFM's with every vacuum chore. The fibrous OFM's are extremely inexpensive, costing only a few pennies each use.

The cleaning and vacuuming performance of the bagless vacuum cleaner is greatly increased by use of the OFM's. The exhaust filters including the HEPA filters last considerably longer because the OFM's capture much of the fine dust particles that plug up these filters. This not only extends the filter life it extends the need for frequent cleaning and replacement of the filters. This saves time and money.

The benefits of the present invention can be achieved in existing cyclone type bagless vacuums without the need for structural changes.

Specifications for the apparatus in accordance with the present invention include the utilization of microfiber 21. A preferred material for the orbit filter magnets 20. Microfibers 21 are dense polyester and polyamide fibers that are about 1/16 the thickness of a human hair. The fibers create microscopic “hooks” which act as claws that grasp and hold dirt and very fine dust particles 30. The positively charged microfibers 21 also attract the negative charged dust particles 30.

The OFM's 20 may have a broad number of shapes, sizes and densities. They may be round, square, triangular or irregular with extended surface areas. The key to best operation is to have a variety of densities, large surface area, properties that allow it to have an electrostatic charge, and be non-abrasive to the clear housing dirt cup. The greater the physical diversity of the OFM's 20 the greater the dust 30 capture coverage within the cyclone. These factors influence the circulating orbit position of the OFM's 20 within the cyclone housing 50 of a bagless vacuum.

The OFM's 20 filter material may be a positive self charging electrostatic material such as microfiber 21 when exposed to air flow such as the circulating air 41 in a cyclone type vacuum cleaner. The OFM 20 will attract negative charged dust 30 by the positive electrostatic charge of the OMF 20 material plus impingement and diffusion on and within microfiber 21 material. Examples of such materials are shown in U.S. Pat. No. 4,229,187 which is incorporated herein by reference.

The OFM's 20 in the preferred embodiment are light in weight and have low density, have a large surface area, be small in size so they circumvent the interior of the clear cyclone housing 50 and dust cup 51 with the bagless vacuum cleaner “on”; be made of a self charging electrostatic material; be non-abrasive, non-toxic, and disposable and inexpensive.

The OFM's 20 in the preferred embodiment may also contain a small quantity of viscous impingement oil 22 such as mineral oil. Using OFM's 20 made with microfiber 21 material coated with viscous impingement 22 mineral oil help capture and hold onto more of the fine dust 30 particles than without. Even a very small amount of mineral oil 22 or other viscous impingement 22 oil improves dust capture and holding performance.

The vacuumed air 40 entering the cyclone portion of the cyclone 50 dust cup is tangential and circumvents the interior of the cyclone 50 dirt cup at high velocity that may be thousands of times a minute. The velocity may be 4,000 feet per minute. The heavier particles 31, 32 tend to stay in the greater orbit portion of the cyclone 50 interior longer and making many rotations before descending to the bottom of the dust cup 51. The lighter and very fine dust 30 particles tend to be closer to the vortex tube 53. They may make fewer rotations before entering the vortex 53 exhaust tube leading to the filters 54.

The preferred OFM 20 density may range from 2 to 10 pounds per cubic foot or be similar in the density of the range of dust 30, 31 being treated.

The preferred volume of ⅜″ cube shaped OFM's 20 placed in a cyclone 50 dust cup may be 10 to 20% of the dust cup 51 volume and may be 1 to 3 cubic inches of small OFM pieces. This may weigh 0.1 to 1 ounces. This may equal about 40 to 80 OFM 20 pieces.

The manufacturing cost of these OFM's 20 may be less than 10 cents per filter change. If the dirt cup 51 in the bagless vacuum were changed 50 times a year the cost to maintain a dust 30, 31 free environment would equal $5 per year.

The OFM's 20 dispensed into the dust cup 51 in small plastic packets each time the emptied dust cup 51 is replaced after emptying the collected dust 35. Each packet of OFM's 20 may be held together by a lightweight film or light stick glue that quickly breaks apart when the vacuum is turned “on” thereby releasing all the OFM's 20. They may also be loose pieces in a dispenser container to allow the user to select as many as needed for different size bagless vacuums.

In a variation the OFM's 20 could be manually dispensed into the dust cup 51 by means of a dispenser built onto the cyclone portion of the bagless vacuum. The dispenser may hold dozens of packets of OFM's 20.The longer the OFM's 20 remain in the cyclone 50 dirt cup during vacuuming, the more the fine dust 30 is captured and conglomerated.

In some embodiments a small magnet is attached to the outside or inside of the cyclone housing 50 dirt cup to help create a magnetic field. This will distort the circular path of the circulating air 41, OFM's 20, dust 30,31 particles and any very small ferrous metal particles in the cyclone 50 dust cup and increase the contact of dust particles 30,31 with the OFM's 20. A deflector may be added to the interior of the cyclone 50 dirt cup to distort the circulating air 41 path to more turbulent flow to increase the contact of dust 30,31 particles and the OFM's 20.

The application of this invention 10 has been described for use in a cyclone 50 type bagless vacuum cleaner; however, this technology has application in home and office air cleaning 60 systems, food processing, medical powder processing, agricultural, cyclone dust collectors and other applications where dust collection and control is desired.

Example: A cyclone dust collector may have a small stream of OFM's 20 entering with the entering dust 40 laden air. The heavy dust laden OFM's 35 may descend to the bottom of the cyclone 50 and be screened away and separated from the majority of the collected dust. The collected OFM's 20 may then be cleaned and returned for use or simply disposed of. The fine dust 30 particles, if they have value, such as a chemical dust, that are captured by the OFM's 20 may be cleaned and collected for re-use.

The OFM's 20 may be selected to stay in motion longer by using less dense material. This helps capture the fine dust 30 particles. The cyclone 50 separation technology is mainly efficient in capturing the larger and heavier particles 31. Cyclones 50 without OFM's 20 are very inefficient in collecting the fine light dust 30 particles.

The preferred media for producing OFM's include the following: A variety of polypropylene and other polymer media such as PET, PE, PBT, PA, PAL along with a growing list of other materials, some in combination. These are frequently referred to as Meltblown/Microfiber Electrostatically Charged Nonwovens & Nanfiber Filter Media.

These are extensively used in making filters for the air conditioning industry. However, air conditioning filters are designed to filter the air as the air flows through the media. The OFM's do not predominately use this through flow method of filtration, hence they may be denser. Being fibrous still allows for air to pass through to allows for deep bed loading of fine dust in the extended interior surface area throughout the OFM but the air pressure drop would not be suitable for just once through air flow for air conditioning applications. The air need not pass through the OFM in order to capture the fine dust particles because both the dust particles and OFM's are circulating at high speed and fine particle capture is by Electrostatic Deposition, Interception, Inertial Impaction and Diffusion.

Testing of the OFM's with a variety of sizes has been conducted. These included individual OFM pieces with dimensions of ⅜″×⅜″×¼″ or ½″×½″×¼ and ⅝″×⅝″×¼″ in combination. The result was very rapid capture of fine dust particles within the dust cup. Virtually no fugitive dust escaped from the dust cup when it was emptied. Improved performance was observed when the OFM's had a very small amount of viscous impingement mineral oil within the OFM's.

The respective item numbers shown in the drawing include:
10 Dust collection invention.
20 Orbit Filter Magnet (OFM).
21 Fibrous or microfiber structure of the OFM.
22 Viscous impingement oil or mineral oil.
30 Fine dust particle.
31 Larger dust particle. This may include carpet fibers and bug parts.
32 Dust clump. This may include large and small particles.
33 Dust clump captured by OFM
34 Large dust clump broke away from OFM.
35 Dust clumps and OFM's that are at bottom of cyclone dirt cup within the housing accumulate particulate matter thereon.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A method for agglomerating dust particles in a cyclone dust apparatus which includes:
providing a cyclone dust removal apparatus that includes a housing;
depositing a plurality of objects having affinity for particulate matter within said housing;
directing a fluid stream having particulate matter disposed therein into the cyclone dust removal apparatus; and
operating the cyclone dust removal apparatus whereby the objects within the housing accumulate particulate matter thereon.

2. The method as described in claim 1 wherein each of the plurality of objects is dimensioned and configured to circulate within the housing of the cyclone dust removal apparatus responsive to fluid flow normally occurring therein.

3. The method as described in claim 2 wherein each of the plurality of objects is porous.

4. The method as described in claim 2 wherein each of the plurality of objects is fabricated from a filter media.

5. The method as described in claim 2 wherein each of the plurality of objects is fabricated from a polypropylene filter material.

6. The method as described in claim 2 wherein each of the plurality of objects has an intermolecular attraction to particular matter in the housing.

7. The method as described in claim 2 wherein each of the respective objects has an electrostatic attraction to particulate matter in the housing.

8. The method as described in claim 2 wherein passage of the object along the interior of the housing creates an electrostatic charge on the respective objects.

9. The method as described in claim 2 wherein the objects are attracted to particulate matter by eddy diffusion.

10. The method as described in claim 2 wherein the objects accumulate particulate matter within the housing as a result of Brownian motion.

11. The method as described in claim 2 wherein each of the plurality of objects is fabricated from a microfiber.

12. The method as described in claim 2 wherein each of the plurality of objects is dimensioned and configured to be light in weight, have low density, have a large surface area, and sufficiently small in size to permit circumvent the interior of a housing.

13. The method as described in claim 2 wherein the plurality of objects includes respective objects that vary with respect to shape, size, density, and/or surface area.

14. The method as described in claim 2 wherein the cyclone apparatus is a vacuum cleaner.

15. A method for agglomerating dust particles in a housing which includes:
providing a housing having upstanding sides, an inlet an outlet;
depositing a plurality of objects having affinity for particulate matter within said housing; and
directing a fluid stream into the housing having particulate matter disposed therein into the housing; whereby the objects are displaced continuously to accumulate particulate matter thereon from the interior of the housing.

16. The method as described in claim 15 further including the step of providing a fan for causing fluid flow in said housing thereby increasing the movement of the plurality of objects and thereby causing additional agglomeration of particulate matter.

17. The method as described in claim 15 wherein each of the plurality of objects is porous.

18. The method as described in claim 15 wherein each of the plurality of objects is fabricated from a filter media.

19. The method as described in claim 15 wherein each of the plurality of objects is fabricated from a polypropylene filter material.

20. A method for agglomerating dust particles which includes:
providing a plurality of objects having affinity for particulate matter within said housing;
causing fluid flow to agitate the objects whereby agglomeration of ambient particulate matter on respective objects occurs.

21. The method as described in claim 2 wherein the plurality of objects are coated with an oil.
